(19) United States
(12) Patent Application Publication
(10) Pub. No.: US 2003/0163357 A1
(43) Pub. Date: Aug. 28, 2003

(54) Method and apparatus for an information systems improvement planning and management process

(75) Inventors: Mark Madison Engleman, Vancouver, WA (US); Fergus Eoin O'Scannlain, Portland, OR (US)

Correspondence Address: Mark Engleman, 607 East Reserve Street, Vancouver, WA, 98661, US

(73) Assignee: SoftSelect Systems, LLC, Vancouver, WA

(21) Appl. No.: 10/084,791

(22) Filed: Feb. 25, 2002

(51) Int. Cl. G06F 17/60

(52) U.S. Cl. 705/7

(57) ABSTRACT

A system for comprehensively managing business software (referred to as: enterprise application software—EAS) that runs companies and organizations. Includes methods (100), software application (108), trained personnel (110 and 112) and team collaboration structure (FIG. 7) for developing an EAS plan, improving existing EAS systems and selecting and implementing new EAS systems. The system includes an EAS research component that provides businesses EAS software research, industry and peer group comparisons, and best practices. The EAS research function is comprised of trained personnel, methodology and software applications (291 and 293).

### BACKGROUND—FIELD OF INVENTION

This invention relates to methods and tools for managing software that businesses and organizations use to plan and execute day-to-day operations. It includes methods and tools to model a business's process objectives, manage problems and actions, prioritize improvements actions, detect the correct time to replace business software, and streamline the process of testing candidate business software solutions. Further, this invention includes dynamic and automated collaboration between the business with software under management, external consulting resources, and a research function that collects business software product data and acts as a clearinghouse for best practices.

### BACKGROUND—DISCUSSION OF PRIOR ART

Companies and organizations invest significant financial and human resources in complex business software such as systems that control manufacturing planning and execution, customer management, and accounting. This type of software is called Enterprise Application Software (EAS) in this invention documentation. Selecting EAS is a complex and difficult project. Implementing EAS correctly is one of the most problematic challenges to businesses today. Furthermore, it rarely happens that ongoing improvements to EAS are made proactively to support evolving business processes. To compound the situation, the rate of change in business processes and EAS options is accelerating. The following industry research firms corroborate this situation (ERP and CRM are EAS packages):

Sixty percent of companies indicate an initial negative return on enterprise resource planning (ERP) software investment. That number can run as high as eighty percent, depending on the specific software implemented. Twenty-three months is the average implementation time. (Meta Group—www.metagroup.com)

Ninety percent of ERP implementations end up late or over budget. (Standish Group—www.standishgroup.com)

The failure rate for customer relationship management CRM software projects will rise from the current 65% to over 80% by mid-2003. (Gartner Group—www.gartner.com)

Successful companies gain an edge on their competitors based on their ability to anticipate and plan for innovation with information technology. Picking the right combination of technologies, products and methods can result in market leadership and sustainable competitive advantage; picking the wrong ones can result in losing valuable time, and in some cases, complete failure. (Key IT Trends for 2002, Giga Information Group—www.gigaweb.com)

The current condition of business software in a typical mid-size and smaller company is demonstrated in FIG. 2. A sample firm starts with 1000 requirements 155 (FIG. 4). Initially, current EAS reasonably meets 820 requirements 155 (FIG. 4) for an 82% potential score as shown on the system potential line 116 (FIG. 2). The sample firm is using 500 requirements 155 (FIG. 4) for a 50% utilization score as shown on the system usage line 117 (FIG. 2). The difference between the system potential line 116 (FIG. 2) and the system usage line 117 (FIG. 2) represent requirements 155 (FIG. 4) that are not being used that the current EAS systems can achieve through some legitimate means. The system potential line 116 (FIG. 2) will fall as innovations in business process improvements and new EAS options result in new requirements 155 (FIG. 4), which causes existing EAS systems to become less effective and obsolete over time. The system utilization line 117 (FIG. 2) will fall at about the same rate as the system potential line 116 (FIG. 2) if there is no proactive EAS improvement management plans in place. Additionally, the improvements in new EAS options will cause the performance zone thresholds 170-172 (FIG. 2) to trend upward as leading companies become more competitive because of successfully using new EAS. Periodic increases 118 (FIG. 2) in the system potential line 116 (FIG. 2) represent when the company acquires new software or discovers previously unknown capabilities in current EAS to achieve requirements 155 (FIG. 4) that were previously above the system potential line 116 (FIG. 2). Periodic increases 119 (FIG. 2) to the system usage line 117 (FIG. 2) represent improvement actions where latent EAS system capabilities were made active. When the system usage line 117 (FIG. 2) nears or enters the crises zone 172 (FIG. 2), there is typically a reaction to replace the main EAS system. This occurs at year two and seven. Notice the system potential line 116 (FIG. 2) is in the superior zone 170 (FIG. 2) most of the time, but in reality, most companies do not have a clear idea of their EAS potential. These businesses are simply unhappy, typically blame the existing EAS, and commission a replacement/selection project.

Prior Art for attempting to enable businesses to be successful with EAS was primarily based on the input and efforts of independent advisors and/or to a lesser degree on efforts of company staff members. The advisors offered services to help businesses in selecting and implementing EAS. These services were structured and presented so that the company mainly observed the process and was not empowered to help themselves. We have found no practical service that existed for proactive improvement management. Prior Art improvement actions typically were based on companies reacting to problems, which would result in a project with short time lines and impatient management oversight. The overall effect was that a majority of companies consuming these EAS selection and implementation services and/or depended on internal staff members had negative end results.

EAS selection Prior Art details are provided in this paragraph. Except for very specific software tools and research databases for system selection, independent advisors used methodology that fundamentally was a by-product of their experience. Furthermore, many have experience in one or more EAS systems and therefore have a natural bias toward that software, or worse, have a financial interest in a particular package. The specific commercial tools for EAS system selection have three major shortcomings that are resolved with this EAS management system. First, they attempt to solve only a portion of the EAS selection process and provide no formal structure for the subsequent critical stages. Second, they included static lists of software functionality for consideration that cannot easily be modified and managed. Every business has custom requirements, issues and amplifications to many system requirements that must be captured and managed methodically. Third, software product research provided by these EAS selection tools was either limited (incomplete) and/or not validated.

EAS implementation Prior Art details are provided in this paragraph. After EAS is selected, software experts were hired to assist in EAS implementations. These experts generally followed standard implementation protocols and checklists but fundamentally did not know the process or the political and personnel problems at the business. It was not practical to include in the project the consulting time needed to gain this level of understanding. Further, they typically were not business process improvement experts and therefore would not recognize some or a majority of fundamental issues that would cause problems with the EAS implementation.

EAS improvement management Prior Art basically consisted of companies reacting to problems with their EAS systems. No formalized Prior Art services for EAS improvement management of existing EAS systems was found.

These problems with businesses using EAS did not exist to any substantial degree 5 to 10 years ago. Large companies and organizations have invested in EAS systems for more than 30 years and have generally had the resources and personnel talent to make effective use of them. This is not the case for mid-sized and smaller companies, which make up more than 95% of business entities in the United States. The increased availability of low cost computing resources, specifically hardware, network infrastructure, business software, and collaboration platforms (such as the Internet) have made large EAS improvement options available for all businesses and organizations and there is resultant pressure to take advantage of them. Mid-size and smaller firms have struggled to assimilate these new EAS efficiency improvement options. Large businesses also are experiencing difficulties with the new EAS options, and with their smaller suppliers with supply chain automation, but to a lesser degree.

### OBJECTS AND ADVANTAGES

Accordingly, the main objects and advantages of this EAS management system are its ability to 1) formalize proper EAS management methodology, 2) manage EAS project details, and 3) coordinate and facilitate the appropriate participation by internal company personnel and external experts. As explained in the Background—Discussion of Prior Art section, Prior Art is lacking in all three of these areas.

Main Objects and Advantages #1: To formalize proper EAS management methodology for EAS improvement management, selection, and implementation, there are two major and fundamental project standards necessary. First, there needs to be a deep understanding of what software functionality a business actually needs. Actual need is what a business wants adjusted for necessary changes to its current processes. These process changes are driven by better methods and the constraints and structure of available EAS. Second, EAS improvement project obstacles related to process, political, and personnel aptitude problems need to be identified and resolved. These two major project standards are resolved by the EAS management system. Business process experts and company staff, using specific investigation methodology, first develop the actual company needs. From this planning, financial models showing the estimated net benefit of meeting the company needs can be generated, which is usually significant and provides company management extra incentive for proper EAS project support. Then, EAS project obstacles are identified, again based on input from business process experts and company staff and using specific investigation methodology. With Prior Art these first two project standards generally are not conducted well as consultants and internal staff members have access to minimal appropriate methodology and, in some instances, consultants lack appropriate business process improvement skills relative to the company's industry. Also, the costs to conduct the appropriate level of investigation and to manage the project details with Prior Art methods would be prohibitive.

Main Objects and Advantages #2:

To properly manage EAS project details for EAS improvement management, selection, and implementation projects, an apparatus is required to manage the details of the EAS plan. These details consist of items such as EAS system requirements, issues, tasks, personnel, and include many attributes and explanations of these items. The collection and management of EAS project detail is resolved by the EAS management system. With Prior Art there are no known practical options for specifically managing the comprehensive details for EAS improvement projects. There are software tools for purely managing EAS system requirements and/or custom software development, but these do not solve the specific need for collecting, analyzing, and managing all the EAS project detail in an appropriate collaborative environment. Further they are not part of a larger methodology framework focused on improving package EAS systems and a support strategy that is accessible by even very small companies.

Main Objects and Advantages #3: To coordinate and facilitate appropriate participation by internal company personnel and external experts for EAS improvement management, selection, and implementation, EAS projects require significant coordination and cooperation between the company, external advisors, and software experts. The EAS management system has methodology and software tools that enables and encourages collaboration by appropriate EAS project participants. Key to this is that the company is significantly enabled to control the EAS project. With Prior Art there is no formal method identified to achieve such coordination; enabling the company to take control of the EAS project is nearly non-existent, and they are limited to merely observing a complex and confusing process.

Additional specific objects and advantages of the EAS management system for ongoing EAS system improvement management are that the it makes the best improvement opportunities evident and manages the effort to clear obstacles that impede the process of improving EAS. The EAS management system also includes methods to observe new demands placed on EAS as a result of business process improvement actions so that they are included in EAS improvement planning as soon as possible. Prior Art does not foster The proper level of control to conduct proactive EAS improvement management as such actions typically have been based on a reaction to problems.

Additional specific objects and advantages of the EAS management system for EAS selection are it capabilities to 1) collect and present appropriate and objective business software information to businesses selecting EAS; 2) orchestrate appropriate interface between EAS vendor sales functions and the company; and 3) greatly reduce the bias of any member of the EAS selection team. Prior Art limitations in consultants' experience and/or biases are addressed by the EAS management system. The three shortcomings of commercially available EAS selection tools, discussed in the Background—Discussion of Prior Art section, also are resolved.

Additional specific objects and advantages of the EAS management system for EAS implementation planning and management are that it puts control of EAS implementation in the hands of those who know the business; this is contrary to Prior Art, which puts control in the hands of software experts and consultants. As discussed earlier, but especially important for EAS implementation, the software EAS implementers typically have followed standard implementation protocols and checklists but fundamentally did not know the process, political, and personnel aptitude obstacles at the company. The consulting time needed to gain this level of understanding was not practical to include in the EAS project. Further, they typically were not business process improvement experts and therefore would not usually recognize fundamental issues that could cause problems with the EAS implementation. The EAS management system has resolved this problem.

Further objects and advantages of the invention will become apparent from consideration of the drawings and ensuing description.

### SUMMARY

The invention economically solves the problem that companies and organizations have with not having business software properly support business processes.

### DRAWINGS

In the drawings, closely related figures have the same number but different alphabetic suffixes.

FIG. 1: Top-level flow chart describing the EAS management system.

FIG. 2: Graphical representation of Prior Art for EAS management.

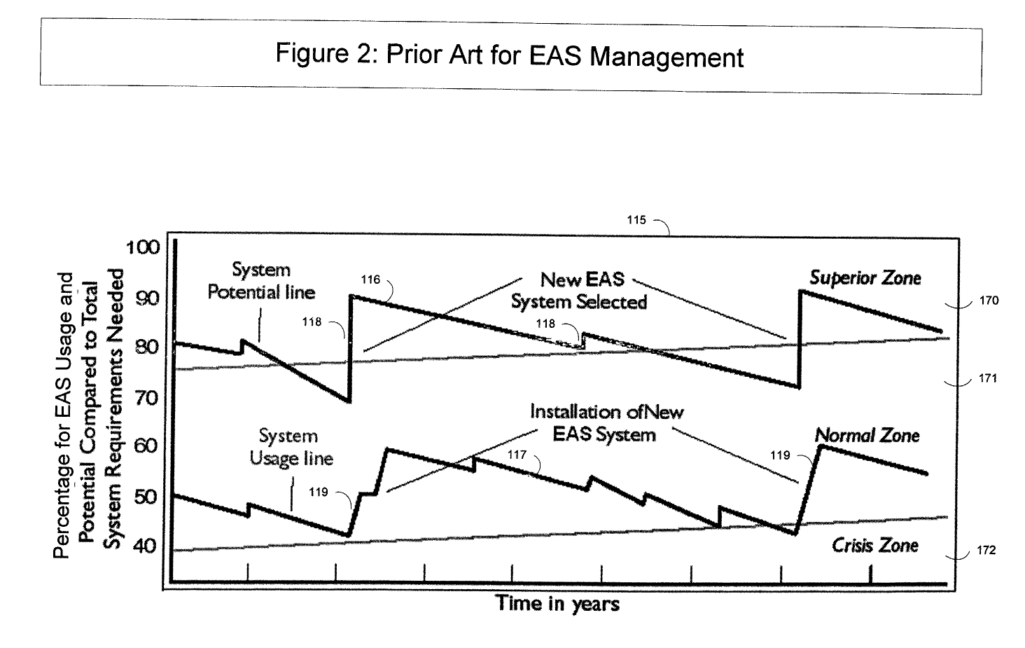

FIG. 3: Enterprise Application Software—Example for manufacturing firm.

FIG. 4: EAS Management Application Data Structure.

FIG. 5: EAS improvement management methodology.

FIG. 6: Graphical representation of sample company under EAS improvement management.

FIG. 7: Entity collaboration for Enterprise Application Software (EAS) improvement management

FIG. 8: EAS product research process

### DETAILED DESCRIPTION

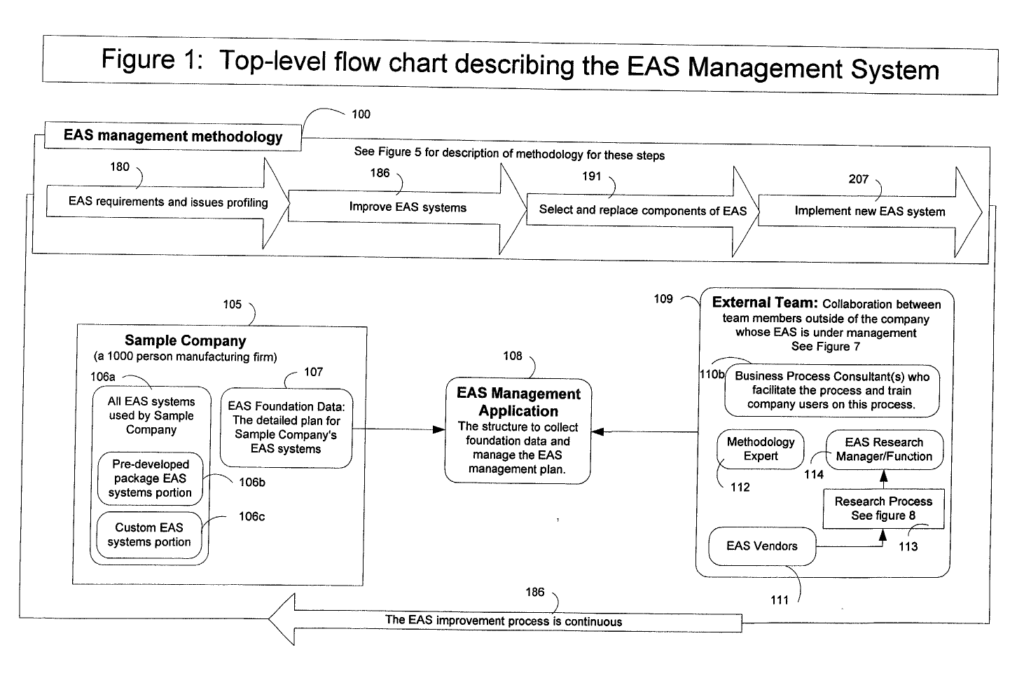

### Descriptions—FIG. 1—Preferred Embodiment

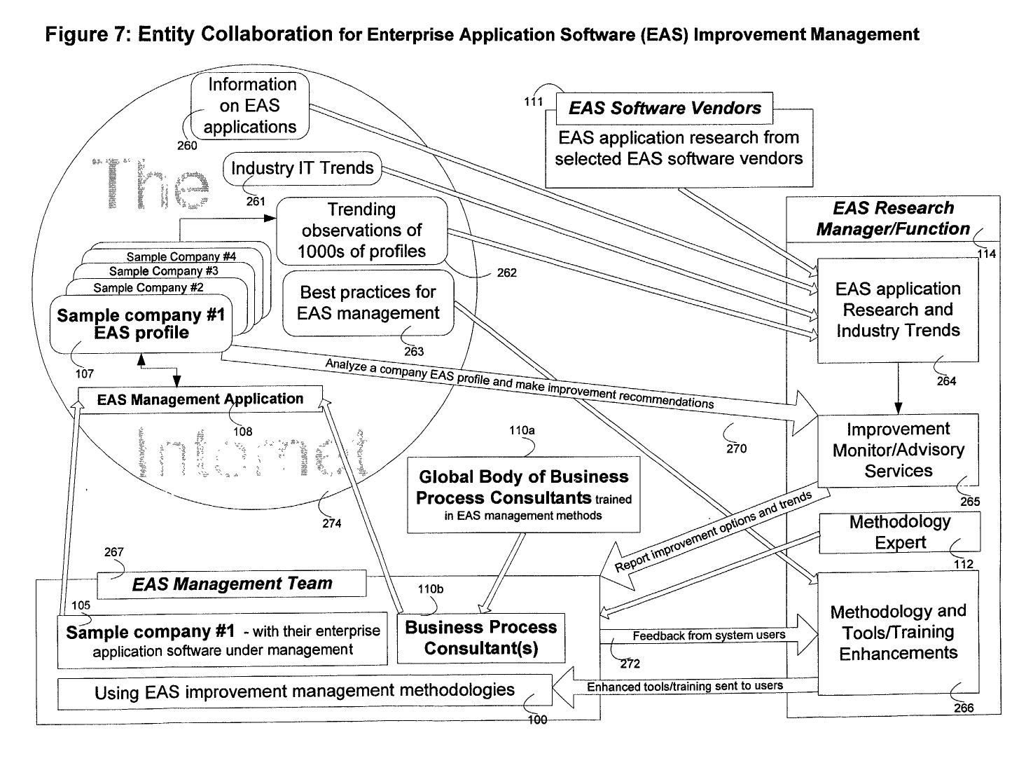

The preferred embodiment of the invention, a process to manage enterprise application software (EAS), is shown in FIG. 1 and FIG. 7, which show the major elements in the total process. The first major component is methodology 100 (FIGS. 1&7), specifically requirements and issues profiling techniques 180 (FIGS. 1&5) to establish a company's EAS foundation data, develop a plan for and put in place a process of prioritized EAS system improvement 186 (FIGS. 1&5), to detect the correct time to replaces some or all of the EAS, and to execute a process for EAS system selection 191 (FIGS. 1&5), and to implement new EAS systems 106a (FIG. 1) with the EAS system implementation planning and management process 207 (FIGS. 1&5) process. The second major component is the company's 105 (FIGS. 1&7) process used, specifically comprised of the current EAS systems 106a (FIG. 1) that is under management and the EAS foundation data 107 (FIGS. 1&7) that describes their EAS objectives and constraint. The third major component is an EAS management application 108 (FIGS. 1&7 and reference application CD) to collect and manage the EAS foundation data 107 (FIGS. 1&7). The fourth major component is the external team that provides expertise 109 (FIG. 1). Specifically made from the business process consultant 110b (FIGS. 1&7) trained in the methodology 100 (FIGS. 1&7), methodology subject matter expert 112 (FIGS. 1&7), and information and consulting support from EAS Vendors 111 (FIGS. 1,7&8). The information from EAS Vendor 111 (FIGS. 1,7&8) is obtained with specific research process 113 (FIG. 1) and coordinated by the EAS research management function 114 (FIGS. 1,7&8).

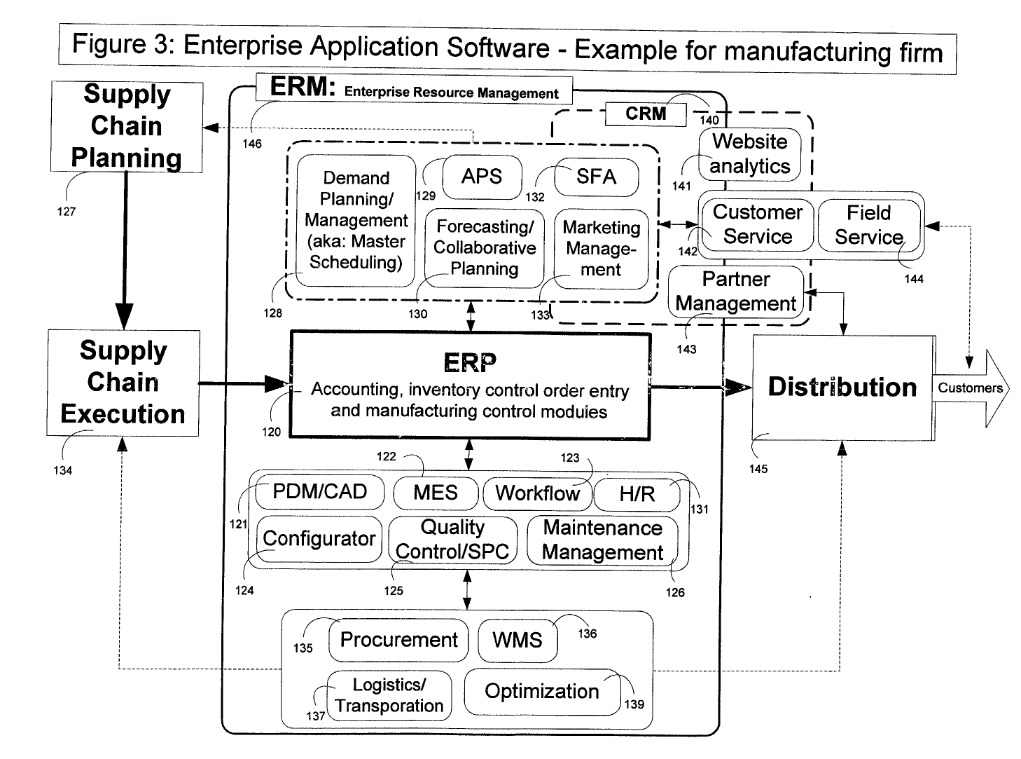

A factor of increased options for EAS that facilitates business process is demonstrated in FIG. 3 with an example manufacturing firm. This collection of EAS type packages and names, in FIG. 3, is an evolving area. This example is presented to show the quantity and challenge to select, implement, integrate, and manage so many separate complex systems. The core EAS package is ERP 120 (FIG. 3) and has typical functionality for manufacturing control, order entry, inventory control, and typical accounting. EAS types for internal planning and work execution are product data management PDM/computer aided design (CAD) 121 (FIG. 3), manufacturing execution systems (MES) 122 (FIG. 3), workflow systems 123 (FIG. 3), product configurator for estimating and order entry 124 (FIG. 3), quality control and statistical process control systems (SPC) 125 (FIG. 3), maintenance management systems 126 (FIG. 3), and Human Resource (HR) systems 131 (FIG. 3). The planning for supplies and materials is handled by Supply Chain Planning software 127 (FIG. 3) and is substantially driven by functionality for understanding known demand 128 (FIG. 3), advanced planning and scheduling (APS) 129 (FIG. 3), forecasting predicted orders 130 (FIG. 3), sales force automation (SFA) 132 (FIG. 3), and managing marketing activities 133 (FIG. 3). The procurement of supplies and materials is handled by Supply Chain Execution software 134 (FIG. 3) and is substantially driven by functionality for procurement 135 (FIG. 3), logistics and transportation 136 (FIG. 3), warehouse management systems (WMS) 137 (FIG. 3), and software to optimize this complex activity 139 (FIG. 3). Another major EAS product type is Customer Relationship Management (CRM) 140 (FIG. 3) that has major components of sales force automation (SFA) 132 (FIG. 3), marketing management 133 (FIG. 3), customer service 142 (FIG. 3), distribution partner/value added reseller management 143 (FIG. 3), and website analytics 141 (FIG. 3). Then field service software to manage the efforts of field service teams and their demands for parts and materials 144 (FIG. 3), distribution software 145 (FIG. 3), which substantially uses the same EAS types as Supply Chain Execution 134 (FIG. 3). Finally the major software type of enterprise resource management (ERM) 146 (FIG. 3) substantially includes all the software discussed in this section.

Develop the Company EAS Foundation Data

Back to FIG. 1, a company's 105 (FIGS. 1&7) EAS foundation data 107 (FIGS. 1&7) is the material information about EAS requirements, issues, and details about a business and its current EAS systems 106a (FIG. 1). This data is used for proactive and prioritized EAS improvement actions. Before describing the methodology to collect the EAS foundation data 107 (FIGS. 1&7) a description is presented of the EAS foundation data 107 (FIGS. 1&7) and how it is recorded in the EAS management application 108 (FIGS. 1&7 and reference application CD).

The EAS Management Application for Capturing EAS Foundation Data

Revisit the context of the EAS foundation data 107 (FIGS. 1&7) and the EAS management application 108 (FIGS. 1&7) that collects and manages this data. All parties, comprised of the company 105 (FIGS. 1&7), business process consultant 110b (FIGS. 1&7), and the EAS methodology expert 112 (FIGS. 1&7) participate in collecting the EAS foundation data 107 (FIGS. 1&7) and the EAS system improvement management process. They all use the EAS management application 108 (FIGS. 1&7) in a collaborative environment. The type of information collected during requirements/issues profiling interviews for any type of EAS under management (see FIG. 3 for examples) are changes, additions and/or amplifications to EAS system requirements, issues or problems, tasks or actions items, and persons and groups of persons that are responsible for issues, tasks, and requirements.

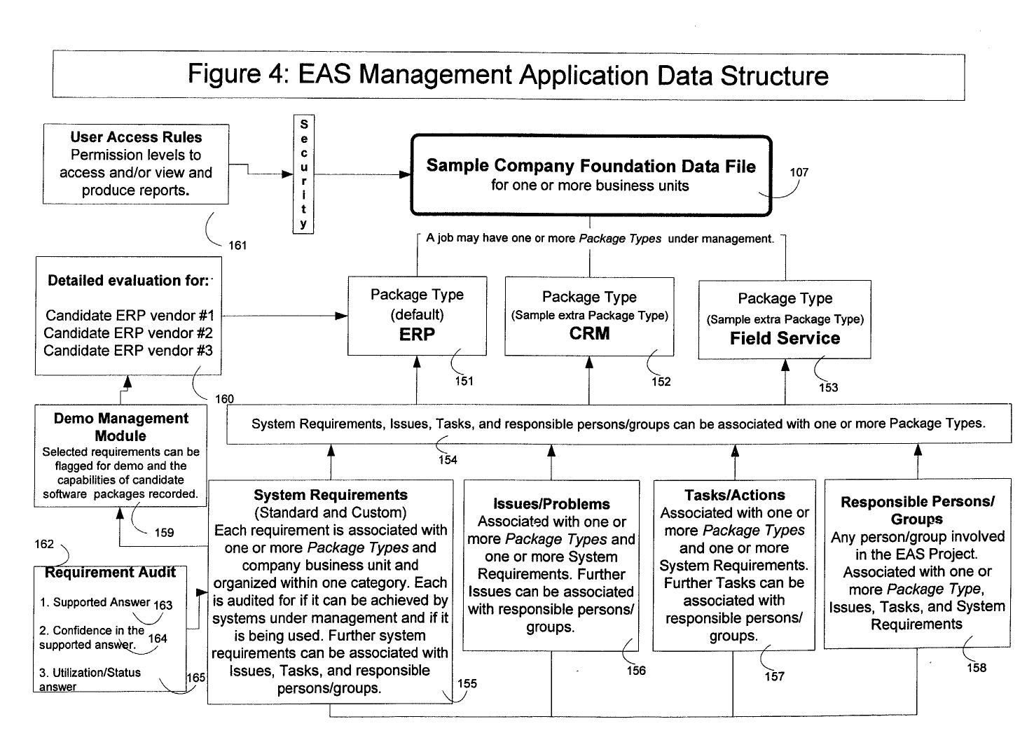

Turn now to FIG. 4 for a description of the EAS foundation data 107 (FIGS. 1&7) and the structure provided by the EAS management application 108 (FIGS. 1&7). The sample company has multiple profiles for multi-location companies or for different companies. The EAS management application 108 (FIGS. 1&7 and reference application CD) can manage these complex situations.

Under the sample company 105 (FIGS. 1&7) EAS foundation data 107 (FIGS. 1&7) are detailed specifications of specific EAS under management 151-153 (FIG. 4), called package types. The examples are EAS packages Enterprise Resource Planning (ERP) 151 (FIG. 4), Customer Relationship Management (CRM) 152 (FIG. 4) and Field Service 153 (FIG. 4). All requirements, issues, tasks, and persons and groups must be associated with at least one Package Type 154 (FIG. 4) when entered. All descriptions of managing company EAS foundation data 107 (FIGS. 1&7) are conducted in the EAS management application 108 (FIGS. 1&7 and reference application CD).

EAS requirements 155 (FIG. 4) are comprised of pre-configured or built-in requirements (pre-loaded in the EAS management application 108 (FIGS. 1&7 and reference application CD)) that describe standard functionality to be considered and custom requirements for the company 105 (FIGS. 1&7) with EAS systems 106a (FIG. 1) under management. The EAS management team 267 (FIG. 7) contacts the EAS research manager 114 (FIGS. 1,7&8) for industry or EAS application type pre-configured requirements. Once a requirement is accepted or entered it is either automatically or manually associated with a Package Type such as ERP 151 (FIG. 4). Requirement attributes are then attributed and denote the value of the requirement (weighting as shown by the four values of critical, high, medium, and low). Requirements can be associated with one or more Issues 156 (FIG. 4), Tasks 157 (FIG. 4) and Responsible Persons/Groups 158 (FIG. 4) as needed. The EAS management application 108 (FIGS. 1&7 and reference application CD) has functions to transfer requirements from one category to another and to move a group of requirements from a Package Type such as Field Service 153 (FIG. 4) to another Package Type such as ERP 151 (FIG. 4).

Issues 156 (FIG. 4) are considered any outstanding problem or uncertainty that is encountered. They can be related to any aspect of the EAS improvement project or about an unrelated process problem. Issue 156 (FIG. 4) can cross-reference to Package Type(s) such as CRM 152 (FIG. 4), requirements 155 (FIG. 4), and persons and groups 158 (FIG. 4), to facilitate their resolution. Attributes are applied to all Issues 156 (FIG. 4) to enable focused and prioritized management and include, priority, topic, status, cost to resolve, benefit if resolved, date to start, and date to end.

Tasks 157 (FIG. 4) are considered any action that is encountered and/or developed as Issues 156 (FIG. 4) are processed. They can be related to any aspect of the EAS improvement project or about an unrelated process problem. Issues 156 (FIG. 4) can cross-reference to Package Type(s) such as ERP 151 (FIG. 4), requirements 155 (FIG. 4), and persons and groups 158 (FIG. 4), to facilitate their execution. Attributes are applied to Tasks 157 (FIG. 4) to enable focused and prioritized management and include, priority, topic, status, cost to accomplish, and benefit if accomplished, date to start, and date to end.

Responsible Persons and Groups 158 (FIG. 4) are any person or groups that have an interest in or responsibility for aspects of any Issue 156 (FIG. 4), Task 157 (FIG. 4) or requirements 155 (FIG. 4) recorded in the company EAS foundation data file 107 (FIGS. 1&7). They can be related to any aspect of the EAS improvement project or about an unrelated process problem. Responsible Persons and Groups 158 (FIG. 4) can cross-reference to Package Type(s) such as Field Service 153 (FIG. 4), requirements 155 (FIG. 4), Issues 156 (FIG. 4), and Tasks 157 (FIG. 4). The EAS management application 108 (FIGS. 1&7 and reference application CD) produces planning reports to show specific Package Type(s) such as Field Service 153 (FIG. 4), requirements 155 (FIG. 4), Issues 156 (FIG. 4), and Tasks 157 (FIG. 4) related and outstanding for a specific Responsible Persons and/or Groups 158 (FIG. 4).

Initial Requirements and Issues Profiling

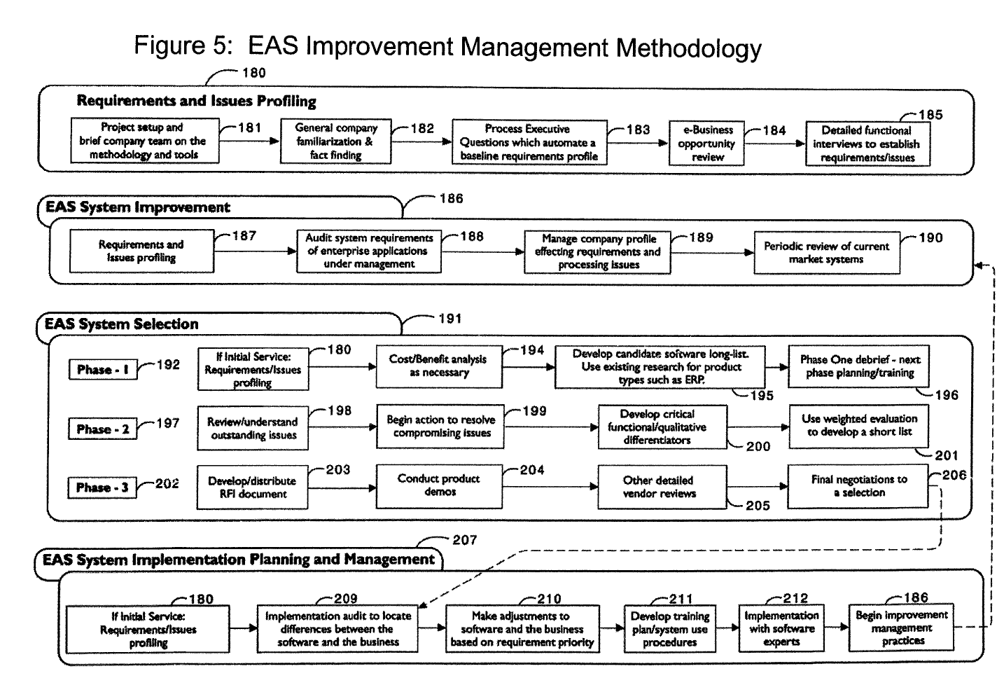

Requirements and issues profiling is the initial phase, which is the basis for any EAS improvement management work to develop the EAS foundation data 107 (FIGS. 1&7). Turn to FIG. 5 to see a total representation of the EAS improvement management process and the element of the flow chart for requirements and issues profiling 180 (FIGS. 1&5).

The project setup phase 181 (FIG. 5) is a preparation and planning stage for the immediate project team to ensure the team and company are ready to proceed. This team consists of members from the company 105 (FIGS. 1&7) with EAS systems 106a (FIG. 1) under management and members of the external team 109 (FIG. 1), specifically the business process consultant 110b (FIGS. 1&7) and if needed software product research from the research manager 114 (FIGS. 1,7&8). For more complex EAS improvement projects the methodology expert 112 (FIGS. 1&7) is involved.

The company 105 (FIGS. 1&7) familiarization phase 182 (FIG. 5) includes a thorough company walk-through and research into the company's industry. A meeting follows this with general and departmental management to gain an understanding of their goals and concerns and discuss the need for process re-engineering and project related education. The business process consultant 110b (FIGS. 1&7) typically sets up the EAS management application 108 (FIGS. 1&7 and reference application CD) for a specific company project.

Begin the formal business process/requirements review 183 (FIG. 5) by processing a set of general questions, called Executive Questions, to the company executives. The EAS management application 108 (FIGS. 1&7 and reference application CD) has an expert process that links the Executive Questions with a larger set of statements of system functionality. By virtue of the way the Executive Questions are answered, they will automate an initial requirements profile for standard accounting and operational system functions. This process provides a useful forum wherein senior and departmental management can discuss the project in a structured and comprehensive environment. These discussions can demonstrate management's attitude toward the project and how it can affect the project by uncovering philosophical alignments or conflicting visions.

Conduct the e-Business opportunity review 184 (FIG. 5), which is a diagnostic that detects e-Business potential at the company 105 (FIGS. 1&7). This is comprised of a series of questions presented to departmental/functional managers. These managers record a numerical score and an automated process produces results that show the relative importance of e-Business type functionality for each function under review at the company 105 (FIGS. 1&7). The results influence the functional interviews 185 (FIG. 5) to establish the details of the e-Business plan that then are recorded with other system requirements 155 (FIG. 4), Issues 156 (FIG. 4), and Tasks 157 (FIG. 4) in the EAS management application 108 (FIGS. 1&7 and reference application CD).

Functional interviews 185 (FIG. 5) to establish appropriate requirements 155 (FIG. 4), Issues 156 (FIG. 4), and Tasks 157 (FIG. 4), for package types under study, such as ERP 151 (FIG. 4) are the key to the process. The business process consultant 110b (FIGS. 1&7) prepares those to be interviewed with training on the overall process 181 (FIG. 5), and specific instructions to review and comment on the automatically answered requirements for standard accounting and operational system functions. Company 105 (FIGS. 1&7) department management, system users, and representatives from other business functions that significantly interface with the function being reviewed participate. The interviews are lead by the business process consultant 110b (FIGS. 1&7) and results are captured using a tape recorder or by an assigned scribe. The interview begins by the business process consultant 110b (FIGS. 1&7) by having the company 105 (FIGS. 1&7) members from a particular function provide an overview of the transactions and process flow. Next discussed are the automatically answered requirements, workflow problems, manual, ineffective, and error-prone steps, and what users like about current systems. After the interview and as soon as practical the findings are recorded in the EAS management application 108 (FIGS. 1&7 and reference application CD). To better optimize the differentiating requirements for selection, implementation planning, and/or improvement management, the requirement 155 (FIG. 4) weightings are spread in the following approximate percentages: <5% weighted Critical, 15% to 20% High, 50% to 60% Medium, and 20% to 30% Low. The EAS management application 108 (FIGS. 1&7 and reference application CD) has reporting that calculates these percentages automatically. Requirements 155 (FIG. 4) are organized by category and if the appropriate category is not available, it can be entered in the EAS management application 108 (FIGS. 1&7 and reference application CD).

Research Process

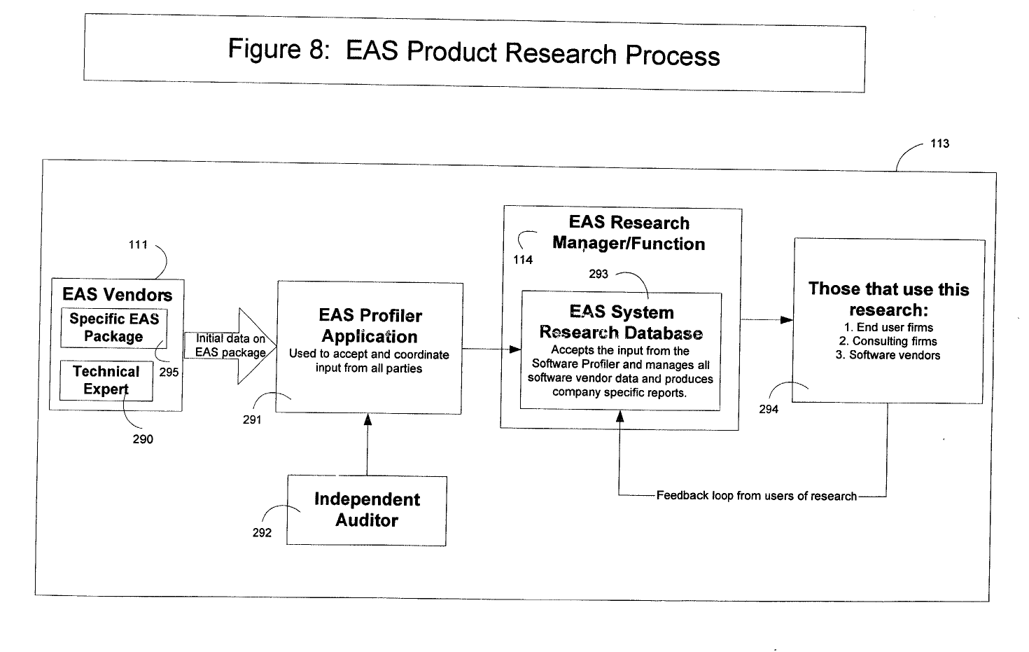

EAS product research process 113 (FIGS. 1&8) is completely demonstrated in FIG. 8. The process to enter and maintain research about a particular EAS vendor's 111 (FIGS. 1,7&8) product(s) begins with the EAS research manager/function 114 (FIGS. 1,7&8) contacting the new EAS vendor 111 (FIGS. 1,7&8). EAS vendor's 111 (FIGS. 1,7&8) product line management is briefed on the purpose and research techniques used and a technical expert 290 (FIG. 8) in the particular EAS is selected. This technical expert 290 (FIG. 8) is trained on the use of the EAS profiler application 291 (FIG. 8 and reference application CD), a software tool used to record and refine information about a specific EAS 295 (FIG. 8). The technical expert 290 (FIG. 8) proceeds to answer standard questions presented in the EAS profiler application 291 (FIG. 8 and reference application CD). The six answers codes for functionality questions about the particular EAS 295 (FIG. 8) are:

Yes=A software clearly has the functionality in question either in its base configuration or through built-in, user accessed, customizing functions; or a software accomplishes most of what is stated and/or the functionality implied by a software functionality question and there are easy and reasonable workarounds to accomplish the rest of the functionality.

No=A software does not accomplish the function in question; it accomplishes less than half of what is stated and/or implied by the question and there are no reasonable workarounds.

Yes/C=A software accomplishes less than half of what is stated and/or the functionality implied by the question and there are reasonable workarounds.

Yes/3p=A software accomplishes a function by the use of an established third-party product. Established denotes a third-party partner with verified functionality that is appropriately connected to an application. This third party-functionality should be accessible and useable as if it were part of the core application.

Yes/F=To denote that a function will be included in the next release.

Unclear=To denote that a functionality question is not clearly defined and needs more amplification from the EAS research manager 114 (FIGS. 1,7&8).

In addition to collecting and managing functionality data the EAS profiler application 291 (FIG. 8 and reference application CD) has data fields for recording other information about EAS software vendor's 111 (FIGS. 1,7&8) products such as specifications (e.g. hardware on which the EAS runs), pricing, number of install, preferred industries and sizes of firms for which the specific EAS 295 (FIG. 8) is suitable, and fundamentally is designed to capture useful information on EAS vendors 111 (FIGS. 1,7&8) and specific EAS 295 (FIG. 8). From expert review of the software by the auditor 292 (FIG. 8) and feedback of companies using the particular software, ratings for EAS software usability and quality of training and support are developed. These ratings are very important for companies such as the sample company 105 (FIGS. 1&7) and positively influence EAS vendors 111 (FIGS. 1,7&8) to improve this important service.

After the EAS vendor's technical expert 290 (FIG. 8) completes the functionality questions, an independent auditor 292 (FIG. 8) reviews the findings. Independent auditors 292 (FIG. 8) are individuals or groups, screened by the EAS research manager 114 (FIGS. 1,7&8), which is knowledgeable about the particular EAS vendor 290 (FIG. 8) and specific EAS 295 (FIG. 8). They have no financial connection to the specific EAS vendor 290 (FIG. 8). They can be business process consultants 110b (FIGS. 1&7) who use the EAS improvement management methodology 100 (FIGS. 1&7) with companies 105 (FIGS. 1&7). The auditor is trained on using the EAS profiler application 291 (FIG. 8 and reference application CD) and audits the answers provided by the technical expert 290 (FIG. 8). Using the same answer codes, the auditor challenges and may change functionality answers. For changes the auditor 292 (FIG. 8) provides a confidence data value, which measures the auditor's level of confidence in the answer modification. When the audit is complete the software vendor 111 (FIGS. 1,7&8) is provided the updated data profile and in the EAS profiler application 291 (FIG. 8 and reference application CD) produces a report that shows the changed answers to functionality questions and can challenge these changes. Data fields are available in the EAS profiler application 291 (FIG. 8 and reference application CD) for the technical expert 290 (FIG. 8) to apply any challenges to the auditor's 292 (FIG. 8) answers and amplification notes. The EAS research manager 114 (FIGS. 1,7&8) receives this data into the EAS System research database 293 (FIG. 8 and reference application CD), which automatically accepts the input from both parties, based on modifiable rules. These rules observe the auditor's 292 (FIG. 8) confidence level in the answer changes and automatically accepts auditor 292 (FIG. 8) functionality responses with a higher confidence and automatically accepts EAS vendor's technical expert 290 (FIG. 8) answers where the auditor's 292 (FIG. 8) confidence was lower. This automation is provided by the EAS profiler application 291 (FIG. 8 and reference application CD).

Another cleansing of the specific EAS 295 (FIG. 8) product data occurs from those that use this data 294 (FIG. 8). Their feedback is collected and the auditors 92 (FIG. 8) check it for validity.

The structure of this data collection process encourages the EAS vendors 111 (FIGS. 1,7&8) to be more diligent and provide reasonable responses. They realize all EAS vendors 111 (FIGS. 1,7&8) in the EAS systems research database 293 (FIG. 8 and reference application CD) are audited and therefore when users use the research data for improvement management and replacing EAS, that their software will be able to fairly compete.

EAS Improvement Management

After the initial requirements/issues profiling is completed, the EAS management team 267 (FIG. 7) will audit existing EAS systems 106a (FIG. 1) to develop an understanding of its total potential and level of utilization.

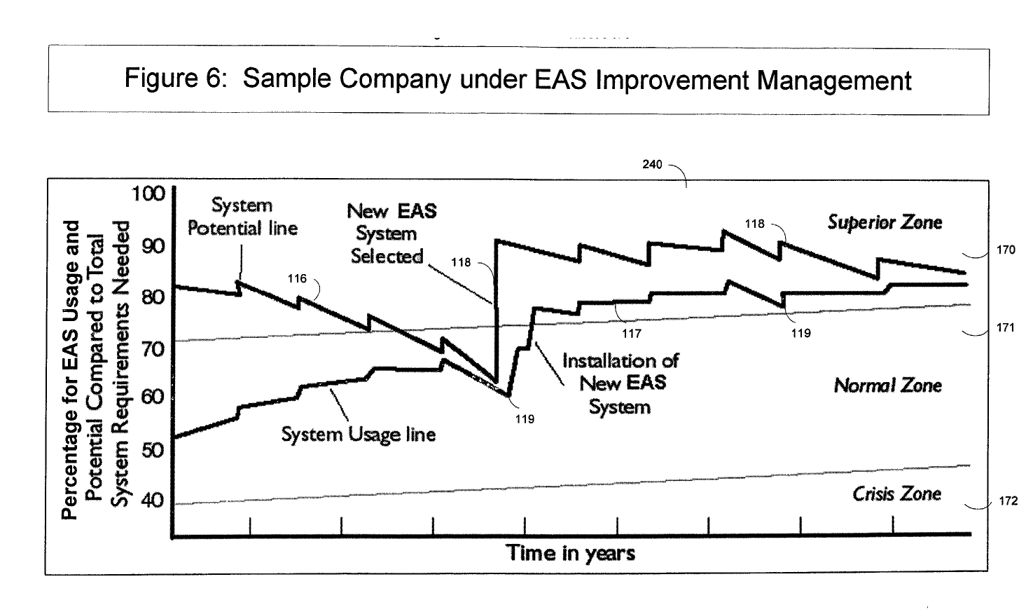

Before a description of procedures, turn to FIG. 6 for a graphical representation 240 of a company under proactive EAS improvement management. The graph 240 (FIG. 6) demonstrates the control when EAS system requirements 155 (FIG. 4) are modeled and managed. A sample firm starts with 1000 requirements 155 (FIG. 4). Initially, current EAS reasonably meets 820 requirements 155 (FIG. 4) for an 82% potential score as shown on the system potential line 116 (FIG. 6). The sample firm is using 500 requirements 155 (FIG. 4) for a 50% utilization score as shown on the system usage line 117 (FIG. 6). The difference between the system potential line 116 (FIG. 6) and the system usage line 117 (FIG. 6) represent requirements 155 (FIG. 4) that are not being used that the current EAS systems can achieve through some legitimate means. This is the group of requirements that are managed and incrementally achieved, which causes the system usage line 117 (FIG. 6) to move toward the system potential line 116 (FIG. 6). Significant increases 119 (FIG. 6) in the system usage line 117 (FIG. 6) represent major improvement efforts.

The system potential line 116 (FIG. 6) will fall as innovations in business process improvements and new EAS options result in new requirements 155 (FIG. 4), which causes existing EAS systems to become less effective. Occasional spikes 118 (FIG. 6) in the system potential line 116 (FIG. 6) are based on a sample firm acquiring new software capabilities to meet the requirements 155 (FIG. 4) above the system potential line 116 (FIG. 6). The sample firm starts with only half of all requirements 155 (FIG. 4) being met with a 50% initial system usage line 117 (FIG. 6). This is mid-way in the normal zone 171 (FIG. 6) of systems effectiveness. During the first three years the sample firm makes many EAS improvements, causing the system usage line 117 (FIG. 6) to move toward the system potential line 116 (FIG. 6) until the two nearly converge at year four. At this point a full 38% of all known requirements are not met by the EAS system and a replacement project is justified. After selection and implementation both the system potential line 116 (FIG. 6) and system usage line 117 (FIG. 6) are in the superior zone 170 (FIG. 6).

Turn to FIG. 5 for a flowchart of the process for ongoing EAS system improvement 186. The first step is to develop the requirements and issues profile 180 (FIGS. 1&5), which has been described in earlier sections. The next phase is to a conduct a requirement audit 188 (FIG. 5) to develop the company's 105 (FIGS. 1&7) starting points, for existing EAS systems 106a (FIG. 1), on the system potential line 116 (FIG. 6) and the system usage line 117 (FIG. 6). The EAS improvement team comprised of company 105 (FIGS. 1&7) members and external members 109 (FIG. 1) first measures how the company's 105 (FIGS. 1&7) current EAS system 106a (FIG. 1) under management can support established requirements 155 (FIG. 4) and second, which requirements 155 (FIG. 4) are being utilized. All or part of the requirement audit 162 (FIG. 4) is lead by the consultant 110b (FIG. 4) with the help of one or more selected company 105 (FIGS. 1&7) team members, depending on time and company staff resources available. The correct method is influenced by time available from the business process consultant 110b (FIGS. 1&7) and the commitment, knowledge, and availability of the company's 105 (FIGS. 1&7) team.

Referencing back to FIG. 4, for every requirement 155 (FIG. 4) three specific audit data values are collected. The first audit value is the supported data value 163 (FIG. 4), which indicates if and how the EAS system 106a (FIG.1) under management at the company 105 (FIGS. 1&7) meets the requirement 155 (FIG. 4). The second value is confidence 164 (FIG. 4), which indicates how confident the auditor was in the supported data value 163 (FIG. 4) applied to a specific requirement 155 (FIG. 4). The third data element is the utilization/status data value 165 (FIG. 4), which indicates the actual use status of the requirement 155 (FIG. 4).

The supported data field 163 (FIG. 4) records information on how the requirement 155 (FIG. 4) is accomplished by the EAS system 106a (FIG. 1) under improvement management. Response options and option descriptions, which can be enhanced as needed, are:

Yes: If the required functionality 155 (FIG. 4) is automated to a significant degree directly by the EAS system 106a (FIG. 1) and has connectivity for sharing data as one would expect with current market EAS systems.

Yes/Custom: An identified and reasonable customizing option that can accomplish the requirement 155 (FIG. 4) in a significantly automated manner and has appropriate connectivity to other EAS systems 106a (FIG. 1). Additional information should be gathered about details to achieve this. The EAS management application 108 (FIGS. 1&7 and reference application CD) has data fields to capture these amplifications.

Yes/3rd Party: An identified and reasonable third-party package/component that can accomplish the requirement 155 (FIG. 4) in a significantly automated manner and has appropriate connectivity to other EAS (see FIG. 3 for examples). Record details in the EAS management application 108 (FIGS. 1&7 and reference application CD).

Yes/Upgrade: If a requirement 155 (FIG. 4) is to be accomplished through an upgrade to a newer release of the current system. This option applies only in improvement management of existing EAS systems 106a (FIG. 1). Record details in the EAS management application 108 (FIGS. 1&7 and reference application CD).

Yes/Future: If a requirement 155 (FIG. 4) is to be accomplished through functionality in a future release of the existing EAS systems 106a (FIG. 1). Record details in the EAS management application 108 (FIGS. 1&7 and reference application CD).

No: There is not an identified and reasonable method to achieve the requirement 155 (FIG. 4) at this time. The key words are identified and reasonable, as there are obviously workarounds for most any requirement.

Unanswered: The supported response 163 (FIG. 4) for the requirement 155 (FIG. 4) has not yet been considered.

The utilize/status data field 165 (FIG. 4) accepts specific information on how the requirement 155 (FIG. 4) is accomplished by the EAS systems 106a (FIG. 1) under improvement management. Response options and option descriptions, which can be enhanced as needed, are:

Yes: The requirement 155 (FIG. 4) has been verified to be fully in use.

No: The requirement 155 (FIG. 4) is not being fully used.

In Process: The requirement 155 (FIG. 4) is in the process of being effected. Selecting this value removes the requirement 155 (FIG. 4) from appearing on planning reports that study future improvement actions.

Suspended: This value is used when the requirement 155 (FIG. 4) has been put on hold (e.g., fundamental process changes may be required before some requirements can be effected). Selecting this value removes the feature from appearing on normal improvement and implementation planning reports. Consider setting a Task 157 (FIG. 4) for taking action to reconsider or effect this requirement 155 (FIG. 4), and/or enter information in requirement 155 (FIG. 4) notes data field about why it is suspended.

N/A: Used for a requirement 155 (FIG. 4) that is not a description of functionality and not subject to a simple Yes/No answer as to whether it is being used or not. Requirements 155 (FIG. 4) with this value are removed from the EAS Management Application 108 (FIGS. 1&7 and reference application CD) improvement planning reports. For example, the system has to be scalable to 120 users is not a typical business process requirement 155 (FIG. 4).

Unanswered: Whether the requirement 155 (FIG. 4) is being used has not been established.

The person that audits the company's 105 (FIGS. 1&7) current EAS systems 106a (FIG. 1) is typically the business process consultant 110b (FIGS. 1&7) and an assigned member on the company's 105 (FIG.1) EAS management team 267 (FIG. 7). They collect the initial supported audit answers 163 (FIG. 4) by interviewing current users and experts in the particular EAS package. If available, obtain audit information on the specific EAS package from the EAS research manager 114 (FIGS. 1,7&8). The EAS research manager 114 (FIGS. 1,7&8) can automatically input this information into the company data profile 107 (FIGS. 1&7). Each audit answer is given a confidence value 164 (FIG. 4) that demonstrated the auditor's confidence in the accuracy of the supported answer 163 (FIG. 4). The confidence data value 164 (FIG. 4) options are high, medium, and low.

The quality of the initial supported audit responses 163 (FIG. 4) will vary from total accuracy (confidence value 164 (FIG. 4) equals high) to accepting an answer from an unverified source (confidence value 164 (FIG. 4) equals low). Having accurate supported responses 163 (FIG. 4) is the basis for effective and smooth ongoing EAS system improvement 186 (FIG. 5), as well as, EAS system implementation planning and management 207 (FIG. 5). The confidence data field 164 (FIG. 4) enables prioritized requirement-by-requirement 155 (FIG. 4) clarification of supported answers 163 (FIG. 4) resulting in improvement to the supported responses 163 (FIG. 4). This will lead to the discovery of many pertinent software and process issues 156 (FIG. 4).

Confidence answers 164 (FIG. 4) for supported responses 163 (FIG. 4) should be Medium or High to give reasonable credence to improvement (and implementation) planning and execution. At this point the auditing team works more intensely with a software expert (software vendor 111 (FIGS. 1,7&8), VAR, consultant) to better determine specific EAS functionality and strategies to effect functionality and therefore improve the supported values 163 (FIG. 4) on a prioritized list of requirements 155 (FIG. 4). Specific steps are:

Using the EAS management application 108 (FIGS. 1&7 and reference application CD) to develop a standard report, which demonstrates the percent of High, Medium, and Low confidence answers 164 (FIG. 4) for a specific EAS package type presented for all requirements 155 (FIG. 4) and then requirements 155 (FIG. 4) organized by category). This report also shows requirements 155 (FIG. 4) with supported responses 163 (FIG. 4) missing (shown by a supported data value 163 (FIG. 4) of Unanswered).

Select requirements 155 (FIG. 4) to improve the supported answers 163 (FIG. 4). Ideally, there would be solid supported answers 163 (FIG. 4) for all requirements 155 (FIG. 4). If time is not an issue, isolate the subset of requirements 155 (FIG. 4) with a Low confidence value 164 (FIG. 4) and work to improve the answers. Using capabilities in the EAS management application 108 (FIGS. 1&7 and reference application CD), develop a standard report to isolate this subset of all requirements 155 (FIG. 4).

If time is limited, focus on the more important requirements 155 (FIG. 4), those with a High or Critical weighting and Low confidence level 164 (FIG. 4). Isolate this subset of the requirements 155 (FIG. 4) using built-in reporting available in the EAS management application 108 (FIGS. 1&7 and reference application CD).

Refining the confidence level 164 (FIG. 4) answers for the requirements 155 (FIG. 4) is an iterative process. As groups of requirements 155 (FIG. 4) are processed toward a solid supported response 163 (FIG. 4), continue to review further requirement audit responses 164 (FIG. 4) by using the drill down capabilities of reporting features in the EAS management application 108 (FIGS. 1&7 and reference application CD).

When the supported answers 163 (FIG. 4) are completed (regardless of the confidence answers 164 (FIG. 4), develop the system potential statistic, for each EAS under management, in the EAS management application 108 (FIGS. 1&7 and reference application CD). This shows the maximum capability of a specific EAS under management and produces the company's 105 (FIGS. 1&7) current location on the system potential line 116 (FIG. 6).

The EAS management application 108 (FIGS. 1&7 and reference application CD) records requirement audit answers 162 (FIG. 4) for multi-company scenarios by maintaining separate requirements 155 (FIG. 4) for business units and for common requirements providing business units specific utilize/status data fields 165 (FIG. 4).

Many times a requirement 155 (FIG. 4) cannot be effected properly at the company 105 (FIGS. 1&7) because the underlying business process is not properly structured or other obstacles that are not a function of the EAS systems 106a (FIG. 1). In these cases, select the correct supported value 163 (FIG. 4) and record related information in the EAS management application 108 (FIGS. 1&7 and reference application CD) forms for Issues 156 (FIG. 4), Task 157 (FIG. 4), associated Responsible Persons and Groups 158 (FIG. 4), and appropriate notes. As these Issues 156 (FIG. 4) and Tasks 157 (FIG. 4) are processed these obstacles will be removed in a timely and orderly fashion by virtue of their priority and other company financial and personnel resources available.

After requirements/issues profiling 180 (FIGS. 1&5) and the requirements audit 188 (FIG. 5) the EAS management team 267 (FIG. 7) begins conducting an EAS system improvement 189 (FIG. 5), it is important to have a sense for the general capabilities of modern EAS systems before continuing to invest time and financial resources in the improvement of existing EAS systems 106a (FIG. 1). The EAS research manager 114 (FIGS. 1,7&8) provides detailed information on EAS systems 190 (FIG. 5) contained in the EAS system research database 293 (FIG. 8 and reference application CD).

Entity collaboration in EAS improvement management is shown in FIG. 7 and demonstrates the continuous relationship between the EAS management team 267 (FIG. 7), the EAS research manager 114 (FIGS. 1,7&8), and EAS software vendors 111 (FIGS. 1,7&8). The business process consultant(s) 110b (FIGS. 1&7) is one or more consultants comes from a global body of business process consultants 110a (FIG. 7) based on consultant proximity to the company 105 (FIGS. 1&7), experience based on the company's 105 (FIGS. 1&7) size and industry, and EAS package types (e.g. ERP 151 (FIG. 4)) being managed. The global body of business process consultants 110a (FIG. 7) is developed and coordinated by the EAS research manager 114 (FIGS. 1,7&8). Professionalism standards and training on these specific EAS management methods and tool are required to become authorized.

Typically in the company's 105 (FIGS. 1&7) EAS foundation data file 107 (FIGS. 1&7) there is significant outstanding EAS management work that is readily evident from reports and analysis produced in EAS management application 108 (FIGS. 1&7 and reference application CD). A majority of this work is shown on FIG. 6 as all requirements 155 (FIG. 4) between the system potential line 116 (FIG. 6) and the system usage line 117 (FIG. 6). The EAS management team 267 (FIG. 7) pursues this work based on system requirement 155 (FIG. 4) priority, ease of implementation, and availability of company 105 (FIGS. 1&7) personnel and capital.

The business process consultant 110b (FIGS. 1&7) and members of the company 105 (FIGS. 1&7) EAS management team 267 (FIG. 7) collaborate in the EAS management application 108 (FIGS. 1&7 and reference application CD). Because of the fact that some or all members may be at different locations and/or traveling the company 105 (FIGS. 1&7) EAS foundation data 107 (FIGS. 1&7) is made available on a web server for easier access. The EAS management application 108 (FIGS. 1&7 and reference application CD) runs as a standalone system and is installed on a web server for remote access. The EAS management application 108 (FIGS. 1&7) has user-based access levels 161 (FIG. 4) to protect sensitive data from inadvertent change or viewing (this level of user control is not included in the code on the application CD).

Another reason for the company's 105 (FIGS. 1&7) EAS foundation data 107 (FIGS. 1&7) being located on the Internet 274 (FIG. 7) is for the EAS research manager/function 114 (FIGS. 1,7&8) to monitor the company's 105 (FIGS. 1&7) EAS foundation data 107 (FIGS. 1&7).

The EAS research manager/function 114 (FIGS. 1,7&8) conducts diagnostics 270 (FIG. 7) on the company's 105 (FIGS. 1&7) EAS foundation data file 107 (FIGS. 1&7) on a periodic basis and at any other specific times based on late breaking information about new EAS that affects the company 105 (FIGS. 1&7) or significant information about a company's 105 (FIGS. 1&7) peer group. These elements of the EAS management system are described only and this portion of the functionality is not included in the EAS system research database 293 (FIG. 8) code on the application CD. This improvement monitor/advisory service 265 (FIG. 7) provides to the company 105 (FIGS. 1&7) the following types of information:

Suggestions for when to make improvements based on inappropriate large differences in the company's 105 (FIGS. 1&7) current position on the system potential line 116 (FIG. 6) and the system usage line 117 (FIG. 6). Suggestions are made for the overall requirements 155 (FIG. 4) profile and by requirement category (e.g. estimating/quoting).

Requirement 155 (FIG. 4) areas, called categories, which have insufficient amounts of requirements 155 (FIG. 4) based on the size and type of company 105 (FIGS. 1&7).

Suggested new requirements 155 (FIG. 4) based on current market EAS offerings and progressive business process methodology and information about the company's 105 (FIGS. 1&7) current EAS systems' 106a (FIG. 1) capabilities for these new suggested requirements 155 (FIG. 4).

Suggest new Issues 156 (FIG. 4) to consider which upon review for the company 105 (FIGS. 1&7) may distil to new requirements 155 (FIG. 4) or process improvement Tasks 157 (FIG. 4).

Based on the EAS research manager's 114 (FIGS. 1,7&8) knowledge of current market packages, suggested general improvement opportunities based on upgrades to the company's 105 (FIGS. 1&7) existing EAS systems 106a (FIG. 1). Estimated benefits of continuing to improve major EAS types of the existing EAS system 105 (FIGS. 1&7), such as ERP 120 (FIG. 3), as compared to the financial return of upgrading portions of the EAS system 106a (FIG. 1) to current market EAS solutions

Compare how the company's 105 (FIGS. 1&7) system effectiveness is to a peer group of companies 262 (FIG. 7). This is a comparison of the company's 105 (FIGS. 1&7) current position on the system potential line 116 (FIG. 6) and system usage line 117 (FIG. 6). In addition, comparisons about how the company's 105 (FIGS. 1&7) system potential 116 (FIG. 6) and usage 117 (FIG. 6) percentages are trending over time as compared to the peer group 262 (FIG. 7) and the company's 105 (FIGS. 1&7) established EAS improvement plan.

Check the data quality to determine the condition of the company's 105 (FIGS. 1&7) EAS foundation data 107 (FIGS. 1&7) and calculate the financial gain or loss based on their past progress and readiness to make improvements.

Based on the overall condition of the company's 105 (FIGS. 1&7) EAS foundation data 107 (FIGS. 1&7), make general recommendations about high-level strategies for improvement.

For multi-location companies the information provided by the EAS research manager 114 (FIGS. 1,7&8) is presented in an overall company 105 (FIGS. 1&7) view and by business unit within the overall company 105 (FIGS. 1&7).

This offers real-time updates on current market conditions 190 (FIG. 5) for the capability of EAS software vendors 264 relative to the company's 105 (FIGS. 1&7) EAS systems 106a (FIG. 1).

In addition to maintaining information on EAS packages, the EAS research manager/function 114 (FIGS. 1,7&8) is a clearinghouse for best practices 266 (FIG. 7) and other EAS related topics. Information on best practices 263 (FIG. 7) comes from research on the Internet 274 (FIG. 7) and other resources. These also are significantly developed from ideas and suggestions 272 (FIG. 7) from EAS management teams 267 (FIG. 7) as they exercise and conduct the overall EAS improvement management process as shown in FIG. 5. Other information comes from industry forums and other software product information 260 (FIG. 7) and general IT industry information 261 (FIG. 7) available in trade journals and the Internet 274 (FIG. 7). This information is reviewed by the EAS research manager/function 114 (FIGS. 1,7&8) and selected consultants 110b (FIGS. 1&7) and integrated with the baseline EAS management methodology 100 (FIGS. 1&7). These results are distributed back to all EAS management teams 267 (FIG. 7) in the form of updated methodology and enhancement to the EAS management application 108 (FIGS. 1&7 and reference application CD).

Select and Replace Systems

The process for EAS system selection 191 is graphically shown on FIG. 5. The details contained in the company's 105 (FIGS. 1&7) EAS foundation data 107 (FIGS. 1&7) can be presented in the EAS management application 108 (FIGS. 1&7 and reference application CD) to readily show the current EAS system 106a (FIG. 1) potential to meet all requirements 155 (FIG. 4) and the current utilization level 117 (FIG. 6). The EAS research manager 114 (FIGS. 1,7&8) can provide statistics about current market EAS systems to compare to the company's 105 (FIGS. 1&7) current EAS systems 106a (FIG. 1). This research 294 (FIG. 5) is provided on a package type basis, for example ERP 151 (FIG. 4). From this information financial cost benefit studies can be made to detect the financially correct time to replace specific portions of the EAS system 106a (FIG. 1). This is shown in FIG. 6 as the decline in the system potential line 116 in year three that is analyzed to justify a system replacement shown by the large increase in the system potential line 118.

The process for EAS system selection 191 (FIGS. 1&5) is broken into three major phases 192 (FIG. 5), 197 (FIG. 5), 202 (FIG.5).

Phase 1: The phase-1 process 192 (FIG. 5) entails ensuring the requirements profile 180 (FIGS. 1&5) is complete and models requirements 155 (FIG. 4) that are projected to be needed in the next 3 years. Use the interview and data management techniques 180 (FIGS. 1&5) described previously to develop the original EAS foundation data 107 (FIGS. 1&7) for the company 105 (FIGS. 1&7) for improvement management of existing EAS systems 106a (FIG. 1).

If a cost justification analysis 194 (FIG. 5) is necessary, isolate high and critical weighted requirements 155 (FIG. 4) that are not met by current systems and study the value of these functions being automated by modern EAS system. Use reporting capability in the EAS management application 108 (FIGS. 1&7 and reference application CD) to drill down to this subset of system requirements 155 (FIG. 4).

Submit the company 105 (FIGS. 1&7) EAS foundation data file 107 (FIGS. 1&7) to the EAS research manager 114 (FIGS. 1,7&8). The built-in requirements 155 (FIG. 4) (requirements that the EAS research manager 114 (FIGS. 1,7&8) has information on selected EAS packages) contained in the EAS foundation data file 107 (FIGS. 1&7) are compared to the functional capabilities of a list of candidate EAS. This candidate list is initially screened for an appropriate cost and complexity zone, for the size of the company 105 (FIGS. 1&7), and a general suitability match based on the company's 105 (FIGS. 1&7) industry focus. The candidate EAS systems are ranked by an overall percentage functional match to the company's 105 (FIGS. 1&7) requirements 155 (FIG. 4) (that were pre-loaded in the requirements review) and the list is forwarded to the EAS management team 267 (FIG. 7).

If further EAS research is needed the EAS research manager 114 (FIGS. 1,7&8) can produce specific queries into the EAS system research database 293 (FIG. 8 and reference application CD). These queries are based on EAS specific characteristics such as operating system and hardware they run on, and other qualitative data about number of installations, financial condition, usability rankings, and quality of support. Also, data on specific EAS packages, not ranked on earlier reports, can be produced.

The long-list of candidate EAS systems 195 (FIG. 5) is developed by the EAS management team 267 (FIG. 7) from research from the EAS research manager and an independent review by the EAS management team 267 (FIG. 7) of information on the Internet, similar companies as the company for which EAS is being selected. Also reviews of trade journals and industry forums similar of the company 105 (FIGS. 1&7) for which EAS is being selected. The results from all these sources will comprise an appropriately comprehensive long list of candidate solutions.

The company 105 (FIGS. 1&7) management debrief 196 (FIG. 5) is presented by leaders of the EAS management team 267 (FIG. 7) and is designed to relay important information to management that was discovered in the phase-1 process 192 (FIG. 5). Many political, personnel, and process problems, relative to the selection and implementation of the ESA system being selected, are encountered in the phase-1 process 192 (FIG. 5). Company 105 (FIGS. 1&7) management needs to lead the process to make many of these changes.

Phase 2: The phase-2 process 197 (FIG. 5) entails reducing a long-list of EAS candidates for the package type, e.g. ERP 151 (FIG. 4), being selected to a short-list of 2-4 candidates. The process begins by reviewing and processing Issues 156 (FIG. 4) that are important and substantially related to the software project, which is shown as process steps 198 (FIG. 5) and 199 (FIG. 5). Use the reporting capabilities in the EAS management application 108 (FIGS. 1&7 and reference application CD) to filter the subset of Issues 156 (FIG. 4) that meet this criterion. Issues 156 (FIG. 4) should be resolved at least to the extent that it is clear that their final resolution will or will not create significant new requirements or discover current business process obstacles. As Issues 156 (FIG. 4) are resolved, they may spawn other Issues 156 (FIG. 4), Tasks 157 (FIG. 4), and system requirements 155 (FIG. 4), which in turn are resolved in the same way. The prioritized and methodical retirement of Issues 156 (FIG. 4) improves clarity of selection criteria and the ability to prepare new EAS and the business 105 (FIGS. 1&7) for implementation.

Fifteen to 30 critical differentiators 200 (FIG. 5) are developed. Use the capabilities in the EAS management application 108 (FIGS. 1&7 and reference application CD) to develop a report of all critical and high-weighted requirements 105 (FIGS. 1&7) for the package type, such as ERP 151 (FIG. 4), being selected. From this list develop 10 to 15 critical functional differentiators. Additionally, develop 5 to 10 qualitative differentiators. Consider qualitative items such as: cost of total ownership/upgrades, progressiveness of an EAS vendor for e-Business features, progressiveness of an EAS vendor's technology, the financial condition of the EAS vendor, the quality of support (local, etc.), ease of use, scalability of the package, and connectivity to important third-party packages.

All long-list candidate EAS packages are measured against the critical differentiators in a weighted matrix. One axis of this matrix will be the differentiator, which will include a data column for a differentiator weighting (scale of 1-10). The other axis is the long list of candidate EAS systems. A member of the EAS management team 267 (FIG. 7) interviews a knowledgeable person about each EAS candidate on the list and provide a score on the matrix between 0 and 10 for each question asked. For each matrix scoring made, record the confidence in the answers accuracy, using a scale of high, medium, and, low. The matrix will calculate a weighted score for each long-list candidate EAS package (the score is developed from a sum of the product of each differentiator score times the differentiator weighting value). After the first data is collected on the long list candidates, observe the composite scores on the Long-list Matrix 201 (FIG. 5) to see if leading EAS packages are rising to the top. If it is not clear, review current matrix answers and refine the ones with a low confidence. If this does not raise two to four clear EAS system leaders, review the requirements 155 (FIG. 4) for more appropriate differentiators and interviewing EAS vendors until the field has been narrowed to two to four candidates for detailed demonstrations.

Phase 3: The phase-3 process 202 (FIG. 5) entails detailed review of the short list candidate packages (requests for information (RFI) document 203 (FIG. 5), software demonstrations 204 (FIG. 5) (conducted in the demonstration management module 159 of the EAS management application 108 (FIGS. 1&7 and reference application CD)), site visits 205 (FIG. 5), negotiate contracts toward making the selection 206 (FIG. 5).

The request for information (RFI) document 203 (FIG. 5) represents a formal communication with a selected EAS vendor 111 (FIGS. 1,7&8). The RFI document 203 (FIG. 5) included details about the company 105 (FIGS. 1&7) such as the type of business, company size, locations, and trends, company 105 (FIGS. 1&7) plans and goals relevant to the EAS sought. Also, the modules or major areas of functionality in question, the number of concurrent seats required, and current EAS system capabilities and reason a new EAS system is sought.

Further, the RFI document 203 (FIG. 5) asks for details from the EAS vendor 111 (FIGS. 1,7&8) such as, number of installations of the candidate system overall and for companies similar to the company 105 (FIGS. 1&7) selecting a system. Also, EAS vendor's 111 (FIGS. 1,7&8) size, age, and financial condition, user references, technical support/training resources, details of user groups, and estimated total cost of ownership based on the description of need.

Product demonstrations 204 (FIG. 5) are a hands-on review of a candidate EAS that show a series of transactions that model business flow at the company 105 (FIGS. 1&7). Demonstrations of requirements 155 (FIG. 4) should typically be conducted on all short-list EAS candidates 160 (FIG. 4). This is an opportunity to observe general package performance and feel. EAS product demonstrations 204 (FIG. 5) should not be conducted before this time, as it is typically a waste of all parties time. And worse could be misleading for the company 105 (FIGS. 1&7) since their clarity on actual priorities may not be clear.

Use the demonstration management module 159 (FIG. 4) of the EAS management application 108 (FIGS. 1&7 and reference application CD) to manage the demonstration process 204 (FIG. 5). First use system reporting to isolate requirements 155 (FIG. 4) with higher weighting and select from this group the subset to be demonstrated. Selected system requirements 155 (FIG. 4) are then flagged for demonstration in the EAS management application 108 (FIGS. 1&7 and reference application CD). For requirements 155 (FIG. 4) selected for demonstration, record in the requirement specific notes data field of the EAS management application 108 (FIGS. 1&7 and reference application CD), any information available about the type of transactions and volume so the demonstration 204 (FIG. 5) can be better tailored to the company's 105 (FIGS. 1&7) need.

The EAS management team 267 (FIG. 7) schedules demonstrations so that EAS vendors 111 (FIGS. 1,7&8) can be granted an extension without disrupting the timing of the project. Demonstrations 204 (FIG. 5) take up to 8 hours depending on the EAS package type, such as CRM 152 (FIG. 4). Members of the EAS management team 267 (FIG. 7) record how well a candidate package performs a requirement in the EAS management application 108 (FIGS. 1&7 and reference application CD).

The demonstration answer collected for each requirement 155 (FIG. 4) shown by each short-list EAS vendor 160 (FIG. 4) are 1) if the feature is or is not supported (supported response), 2) how well it is supported (score response), 3) how confident the demonstration observer was in these two answers (confidence response), and 4) requirements/candidate, software specific notes. Use the EAS management application 108 (FIGS. 1&7 and reference application CD) to produce a report of the requirements 155 (FIG. 4) to be demonstrated for each member of the EAS management team 267 (FIG. 7) participating in the demonstration.

Support responses: The support response shows how the requirement 155 (FIG. 4) is effected by the candidate EAS package, if at all. The data values are:

Yes: The package directly supports the requirement.

Yes/Custom: The package does not directly support the requirement but the vendor demonstrates that it is feasible and reasonable to customize the package to support the requirement. If able, record the details and estimated costs of this customizing in the Notes field.

Yes/3rd Party: The package does not directly support the requirement but the vendor indicates that a compatible and reasonable third party software is available that does support it. If able, record the details and estimated costs of this third party strategy in the Notes field.

Yes/Future: If the package will support requirement through functionality in a future release.

No: The package does not support the requirement and there are no other reasonable methods identified to accomplish the requirement.

Unanswered: Denotes that the requirement has not been considered for the software package under review.

Score response: Scores ranging from 1 to 5 [5 being the highest] identify how well the candidate EAS package achieved a requirement.

Confidence response: Each member of the EAS management team 267 (FIG. 7) that observes the demonstration 204 (FIG. 5) records their confidence in the support and score answers provided. Typically, any requirement claimed to be achieved through customizing that is not immediately understood or through a third party package should receive a Low confidence value. If there are questions as to the technical experience of the person demonstrating the software, then all requirements that are not immediately observed need to be further confirmed and should receive a Low confidence. This information will be useful for refining the demonstration supported values, if necessary, and for completing the system audit for the package selected. Confidence values can be reviewed and managed with reporting options in the EAS management application 108 (FIGS. 1&7 and reference application CD).

When the demonstration is complete, consolidate the answers from members of the EAS management team 267 (FIG. 7) that observed the demonstration and enter the composite score in the EAS management application 108 (FIGS. 1&7 and reference application CD). A report showing the weighted score for the candidate EAS that was demonstrated is available in the EAS management application 108 (FIGS. 1&7 and reference application CD). This report enables an objective comparison of the functionality review of candidate EAS packages.

Other detailed reviews 205 (FIG. 5) of candidate EAS include site visits or phone interview of current users of candidate EAS systems and visiting user group web site(s) and/or meetings.

Phase-3 of selection 202 (FIG. 5) concludes with final negotiations between the EAS management team 267 (FIG. 7) and candidate EAS vendors 111 (FIGS. 1,7&8) to select an appropriate EAS solution.

Implement New EAS

EAS system implementation planning and management 207 (FIGS. 1&5) is graphically shown on FIG. 5. For the sample company 105 (FIGS. 1&7) the requirements and issues profiling 180 (FIGS. 1&5) has been largely developed in early project stages of EAS system selection 191 (FIGS. 1&5) and initial EAS system improvement 186 (FIGS. 1&5). If EAS system implementation planning and management 207 (FIGS. 1&5) is the initial use of any portion of the EAS management methodology 100 (FIGS. 1&7) the requirements/issues profiling 180 (FIGS. 1&5) is conducted in the same methods described earlier.

The next step is the implementation audit 209 (FIG. 5) of the EAS. This is a process to comprehensively understand how a new EAS will meet a firm's functional requirements. The process locates and resolves issues about the software's suitability that are not thoroughly understood through the process of EAS system selection 191 (FIGS. 1&5). It is executed in the same manner as described earlier for the improvement management audit 188 (FIG. 5).

The audit leader comes from the EAS management team 267 (FIG. 7) and is knowledgeable about the company 105 (FIGS. 1&7) and the objectives for the newly selected EAS management application. They will orchestrate the audit 209 (FIG. 5) and oversee work with vendor/VAR personnel 111 (FIGS. 1,7&8).

Described in another way, the methodology 207 (FIG. 5) and EAS management application 108 (FIGS. 1&7 and reference application CD) manage prioritized changes to the business process, personnel and/or software 210 (FIG. 5) before and during implementation. During the implementation 212 (FIG. 5) the EAS management application 108 (FIGS. 1&7 and reference application CD) continues to manage the requirement 155 (FIG. 4), Issue 156 (FIG. 4), and Task 157 (FIG. 4) details.

When implementation is complete, the new EAS is managed under procedures of EAS system improvement 186 (FIGS. 1&5) discussed earlier.

### Additional Embodiments

Managing components of the EAS systems 106c (FIG. 1) that are produced from custom software development is supported by the EAS management system. Turning to FIG. 3, in describing the preferred embodiment package software products 106b (FIG. 1) such as CRM 140 (FIG. 3) were referenced. Package EAS is defined as EAS that is offered by a software vendor and is substantially ready for use with little or no customizing. For the company 105 (FIG. 1&7), some of the package software products shown in FIG. 3 may have some custom development elements and other major EAS functional needs may be completely generated from custom developed EAS software. The same process as described in the preferred embodiment for developing a company's 105 (FIG. 1&7) EAS foundation data 107 (FIGS. 1&7) is conducted exactly the same regardless of where the company 105 (FIGS. 1&7) expects to find the correct EAS system 106a (FIG. 1) to meet the need. The process of EAS system selection 191 (FIGS. 1&5) can precede exactly the same if there is any expectation that the EAS system 106a (FIG. 1) functionality being sought may be commercially available. If not, the EAS management team 267 (FIG. 7) can present the functional specification produced from the EAS management application 108 (FIGS. 1&7 and reference application CD) to software developers. The functional specification is typically comprised of a list of requirements 155 (FIG. 4) and Issues 156 (FIG. 4) that the EAS management application 108 (FIGS. 1&7 and reference application CD) can output. The presentation and coordination of this plan with a software development team is not contemplated with the EAS management system, as there exists a well-established class of software products and methods for this purpose that was presented in the section Background-Discussion of Prior Art. The remaining major elements of the methodology for EAS implementation planning and management 207 (FIGS. 1&5) and ongoing EAS system improvement 186 (FIGS. 1&5) are executed in the same manner as described in the preferred embodiment, except for the following changes.

The requirements 155 (FIG. 4) to be supported can be flagged as such under the Supported data field 163 (FIG. 4). Since this is a custom EAS system 106c (FIG. 1), use the Supported data field 163 (FIG. 4) value of Yes/Custom. Requirements 155 (FIG. 4) that are not to be supported at this time become part of the outstanding requirements 155 (FIG. 4) for future development or to be achieved in some other way.

The system audit Confidence data field 164 (FIG. 4) can be used to record impressions on how well a requirement 155 (FIG. 4) will be effected by the new custom EAS system 106c (FIG. 1). This is useful to highlight requirements 155 (FIG. 4) on which there is a concern about how a custom EAS system 106c (FIG. 1) or custom functionality of a package EAS system 106b (FIG. 1) will support the requirement 155 (FIG. 4). Flag the requirement 155 (FIG. 4) with a Low confidence 164 (FIG. 4) value and redouble efforts to challenge the new application's design for all requirements 155 (FIG. 4) with a Low confidence 164 (FIG. 4) value. These requirements can be isolated with reporting capability in the EAS management system 108 (FIGS. 1&7 and reference application CD).

When the custom EAS system 106c (FIG. 1) is implemented using the EAS system implementation planning and management process 207 (FIGS. 1&5), ensure its utilization/status data value 165 (FIG. 4) is entered in the EAS management application 108 (FIGS. 1&7 and reference application CD).

Large manufacturing firms have 100s if not 1000s of suppliers that provide them parts, materials, and process services. The coordination of these suppliers is an important topic with large manufacturing firms, especially with new e-business options that are becoming available. The supply chain objectives of large manufacturers are significantly dependent on the EAS system's 106a (FIG. 1) condition of companies 105 (FIGS. 1&7) in the large manufacturing firm's supply chain. The EAS management system can be used to support large manufacturing firm to develop a requirements 155 (FIG. 4) plan that meets their supply chain objectives and an EAS system improvement 186 (FIGS. 1&5) plan can then be effected at individual companies 105 (FIGS. 1&7) in the large manufacturing firm's supply chain so the individual company's 105 (FIGS. 1&7) readiness can be increased for better meeting the large manufacturers supply chain goals. The fundamental use of the EAS management system is the same as is described in the preferred embodiment.

EAS system 106a (FIG. 1) usage training development and procedure writing 211 (FIG. 5) are facilitated by the EAS management application 108 (FIGS. 1&7 and reference application CD). The company's 105 (FIGS. 1&7) EAS foundation data 107 (FIGS. 1&7) priorities and exceptions can be isolated with reporting features in the EAS management application 108 (FIGS. 1&7 and reference application CD) and are used to develop company-specific training courses and user procedures 211 (FIG. 5).

### Alternative Embodiments

EAS vendors 111 (FIGS. 1,7&8) can use the EAS management system directly for EAS implementation planning and management 207 (FIGS. 1&5) and ongoing EAS system improvement 186 (FIGS. 1&5), for the EAS they sell and support, with the same methods described in the preferred embodiment. An alternative embodiment to the preferred use of EAS implementation planning and management 207 (FIGS. 1&5) and ongoing EAS system improvement 186 (FIGS. 1&5) would be for software vendors 111 (FIGS. 1,7&8) to have the EAS management system's functionality of the EAS management application 108 (FIGS. 1&7 and reference application CD) be included directly in their EAS application 106b (FIG. 1). In essence the functionality contained in the EAS management application 108 (FIGS. 1&7 and reference application CD) would now be a new module contained within the EAS vendor's 111 (FIGS. 1,7&8) EAS system 106b (FIG. 1) with dynamic links from the requirements 155 (FIG. 4) plan to actual software functionality. The EAS vendor 111 (FIGS. 1,7&8) could send updated requirement 155 (FIG. 4) profiles to its customers that include, 1) new functionality that a new version of the software 106b (FIG. 1) contains, and 2) test functionality that the EAS vendor 111 (FIGS. 1,7&8) would like to see current customers response to. The company 105 (FIGS. 1&7) would decide if these new functionality (in the form of candidate requirements 155 (FIG. 4)) are needed. If needed the EAS management application 108 (FIGS. 1&7 and reference application CD) functionality could produce automated cost benefit modeling, to help the EAS vendor's 111 (FIGS. 1,7&8) customers assess the appropriateness of the EAS system 106b (FIG. 1) upgrade. This version of the EAS management application 108 (FIGS. 1&7) is describe only and this version of the functionality is not included in the EAS management application 108 (FIGS. 1&7) code on the application CD.

Additional uses for EAS vendors 111 (FIGS. 1,7&8) are to use the EAS system research database 293 (FIG. 8 and reference application CD) to compare their specific EAS system 106b (FIG. 1) to their competitors in general and for specific sales opportunities. Further they can use the trending observations on multiple company profiles 262 (FIG. 7) to better determine what companies in their target market are asking for and in what areas major problem exist for these companies.

An additional use for EAS vendors 111 (FIGS. 1,7&8) is to use a portion of the functionality of the EAS management application 108 (FIGS. 1&7) in the selling process. EAS vendor's 111 (FIGS. 1,7&8) sales personnel can work with a prospect to generate an initial EAS system requirements 155 (FIG. 4) profile using the process that automates an initial requirements plan 155 (FIG. 4) as discussed in the preferred embodiment. This requirements profile 155 (FIG. 4) is based on a set of standard requirements for which there is data on the EAS vendor's 111 (FIGS. 1,7&8) EAS system 106b (FIG. 1). The EAS management application 108 (FIGS. 1&7) has reporting features to illustrate a weighted scoring of how well the EAS vendor's 111 (FIGS. 1,7&8) EAS system 106b (FIG. 1) supports the prospect's needs. EAS vendors 111 (FIGS. 1,7&8) also may order research from the EAS research manager 114 (FIGS. 1,7&8) on competing EAS systems 106b (FIG. 1) based on the prospect specific requirements profile 155 (FIG. 4) generated. This process provides a framework to emphasize a particular EAS system's 106b (FIG. 1) strengths, but also discuss strategies to mitigate any weaknesses (workarounds, customizing, third party add-ons, etc.). With EAS systems 106b (FIG. 1) that are basically a good fit, these weaknesses are typically minor (relative to similar weaknesses in competing solutions), so this becomes an opportunity for the EAS vendor's 111 (FIGS. 1,7&8) sales function to impress the prospect by demonstrating the workaround. This consultative sales process typically is appreciated by prospects. As the EAS vendor's 111 (FIGS. 1,7&8) salesperson makes a credible case for the functionality match, they can proceed to promote other important areas such as service and support. This process can continue with further structured analysis to support the sales effort, product demonstrations, and sets the stage for the use of the EAS management system methods for EAS implementation planning and management 207 (FIGS. 1&5) and ongoing EAS system improvement 186 (FIGS. 1&5). This version of the EAS management application 108 (FIGS. 1&7) is describe only and this version of the functionality is not included in the EAS management application 108 (FIGS. 1&7) code on the application CD.

Application service providers (ASP) offer a service to host EAS systems 106a (FIG. 1) for companies 105 (FIGS. 1&7). The ASP maintains the EAS systems 106a (FIG. 1) on their computer servers and the company 105 (FIGS. 1&7) accesses the EAS system 106a (FIG. 1) remotely. ASPs can use the EAS management system to add further value to their services. Specifically, the EAS implementation management and planning process 207 (FIGS. 1&5) and the ongoing EAS system improvement 186 (FIGS. 1&5). Also, the specific elements of the EAS management system discussed are a practical addition to help ASPs serve their clients better and have a more concrete basis for developing ongoing revenue.

The condition of a company's 105 (FIGS. 1&7) EAS systems 106a (FIG. 1) will increasingly be an indicator of the company's 105 (FIGS. 1&7) health and viability. Statistical representations of a company's 105 (FIGS. 1&7) condition could be produced from the data stored in the EAS management application 108 (FIGS. 1&7 and reference application CD). This representation starts with the company's system potential statistics and system usage statistics, which are automatically calculated in the EAS management application 108 (FIGS. 1&7 and reference application CD).

Insurance companies that insure businesses in general and/or EAS systems specifically could find this information useful. They could use the scores to provide rate adjustments and the global body of data could be used to detect aberrations, industry risk trends, and fraud.

The banking industry could find this information useful as these EAS system statistics have a correlation to the general and therefore financial health of the company. This in turn is used to make decisions about loans and terms.

Mergers and acquisitions (M&A) firms conduct deep reviews of candidate M&A companies and could find statistics about the EAS system 106a (FIG. 1) condition of a company valuable for developing valuations, negotiations, and developing plans for integrating companies EAS systems 106a (FIG. 1).

Other process improvement activity or other diagnostics that are subject to many requirements/objectives, issues/problems, tasks/actions, and personnel involved with processing all these items is a candidate to use the basic data engine of the EAS management application 108 (FIGS. 1&7 and reference application CD). Further, if the new diagnostic is related to business process activities then the network of business process consultants 110a (FIG. 7) could readily be trained to deploy the diagnostic. These consultants 110a (FIG. 7) know the EAS management application 108 (FIGS. 1&7 and reference application CD) and they are business process experts, therefore they can be leveraged to conduct this work which can be helpful to the developer of the new diagnostic. This version of the EAS management application 108 (FIGS. 1&7) is describe only and this version of the functionality is not included in the EAS management application 108 (FIGS. 1&7) code on the application CD.

### CONCLUSION, RAMIFICATIONS, AND SCOPE

Thus the reader will see that the EAS management system has addressed the main problems companies have in using EAS. The EAS management system contains structured and economical methods to 1) formalize proper EAS management methodology, 2) manage EAS project details, and 3) coordinate and facilitate the appropriate participation by internal company personnel and external experts. As explained in the Background—Discussion of Prior Art section, Prior Art is lacking in all three of these areas.

The ramifications of the EAS management system are large. Conservative calculations indicate that a 10% improvement of the System Usage line 117 (from 60% usage to 70% usage) can add 3-5% to a company's bottom line. The tangible benefits to this company are large and there are other intangible benefits that accrue to a more profitable and better run company. The collective effect of many companies conducting practical EAS management would translate to a large efficiency boost to the economy and those employees that work for these companies.

While the above description contains many specifications these should not be construed as limitations on the scope of the invention, but rather as an exemplification of the preferred and alternate embodiment thereof. Many other variations are possible. Accordingly, the scope of the invention should be determined not by the embodiments illustrated, but by the appended claims and their legal equivalents.

1. A method for planning and executing a business software planning and management process applicable to a company or organization, the method comprising the steps of:
Profiling the said company's business software requirements to generate a list of prioritized actions and issues applicable to improving the said company's said business software
using said business software profile and methods, effecting improvement actions for said business, including improving existing business software, selecting and implementing new business software:

2. The method according to claim 1 wherein at least one of the steps are implemented on a computer system.

3. A computer-based method for analyzing a business entity to devise and maintain a business software management plan applicable to the said business entity, the method comprising the steps of:
Conducting a business software profiling of said business entity, said profiling comprising the said business entity's actions and issues applicable to improving the said business entity's said business software;
Storing said profiling in a storage device of a data processing system;
Outputting said profiling, to a second computer to compare said business entity's said business software profile to similar data on other business under said method for managing business software;
Storing said profile to said second computer;
Determining, based upon said stored profiling and said computer processors, what business software improvement actions are appropriate for the said business entity.
